(19) United States
(12) Patent Application Publication
(10) Pub. No.: US 2002/0008231 A1
(43) Pub. Date: Jan. 24, 2002

(54) Integrated vehicle jacks and jacking system

(76) Inventors: Andrew Zachary Glovatsky, Plymouth, MI (US); Robert Edward Belke, West Bloomfield, MI (US); Jay DeAvis Baker, Dearborn, MI (US); Joseph Mario Giachino, Farmington Hills, MI (US); Lakhi Nandlal Goenka, Ann Arbor, MI (US); Myron Lemecha, Dearborn, MI (US)

Correspondence Address: BRINKS HOFER GILSON & LIONE, P.O. Box 10395, Chicago, IL, 60610, US

(21) Appl. No.: 09/904,302

(22) Filed: Jul. 12, 2001

Related U.S. Application Data
(60) Provisional application No. 60/218,493, filed on Jul. 14, 2000.

(51) Int. Cl. B60S 9/02

(52) U.S. Cl. 254/418

(57) ABSTRACT

A vehicle jack adapted to be mounted to a vehicle chassis is provided. In one embodiment, the jack comprises a base member, a guide member, a flexible rod, and an actuator. One end of the rod is fixedly attached to the base member while a second end is slideably disposed within a passageway defined by the guide member. The actuator forces the flexible rod to deform by causing the second end of the rod to move with respect to the passageway. When mounted to a vehicle chassis, the jack is operated by deforming the flexible rod until a support surface, such as the ground, is encountered, and subsequently continuing to deform the rod until the vehicle becomes elevated. A vehicle jacking system incorporating the jacks of the invention is also provided.

### REFERENCE TO PREVIOUS APPLICATION

This application claims the benefit of U.S. Provisional Application No. 60/218,493 filed on Jul. 14, 2000.

### FIELD OF THE INVENTION

The present invention relates to vehicle jacks and jacking systems. More particularly, the invention relates to integrated jacks that can be operated from a remote location.

### BACKGROUND OF THE INVENTION

Jacks are frequently used to elevate a motor vehicle from the ground or other support surface. The use of jacks greatly facilitates maintenance and repair activities, such as changing tires, as well as activities related to removing a vehicle from a captive position, such as mud. Many conventional vehicle jacks are cumbersome and awkward to operate, however, in that they must be removed from a stored location, set up in a proper position, and manually operated to elevate the vehicle.

### SUMMARY OF THE INVENTION

The present invention provides a vehicle jack that can be fixedly mounted to the vehicle chassis in a position optimized for jacking the vehicles, thereby eliminating the need for removing the jack from storage and positioning the jack prior to use.

In one embodiment, the jack comprises a base member, a guide member having first and second opposing faces and defining a passageway between the first and second faces, at least one flexible rod attached to the base member and disposed in the passageway, and an actuator adapted to induce deformation of the rod. One end of the rod is fixedly attached to the base member and the second end is capable of slideable movement within the passageway of the guide member. As such, the rod is able to deform in response to a force by the actuator. The jack operates by deforming the rod until it encounters the ground or other surface, and then continuing to deform the rod until the vehicle is elevated to a desired height.

The jack can be secured to a vehicle chassis such that the jack is stored in an operable position. The position can be optimized for a particular vehicle.

A controller can be operably connected to the actuator and positioned within a passenger compartment of the vehicle such that an occupant of the vehicle can initiate and control deformation of the rod, thereby controlling deployment of the jack. Alternatively, a remote control device can be utilized to control deployment of the jack.

The present invention also provides a vehicle jacking system in which a plurality of jacks in accordance with the present invention are secured to a vehicle chassis and are all operably connected to a controller. The controller can be an in-vehicle mechanical, electrical, or electromechanical controller, or can be a remote control unit. The controller allows an occupant of the vehicle or other appropriate individual to control deployment of the jacks.

### BRIEF DESCRIPTION OF THE DRAWINGS

FIG. 1 illustrates a side view of a vehicle jack in accordance with the present invention.

FIG. 2 illustrates a side view of a vehicle chassis with integrated vehicle jacks in accordance with a first preferred embodiment of the present invention. Panel A shows all jacks in an unactivated state while Panel B shows one jack in an activated state.

FIG. 3 illustrates a side view of a vehicle chassis with integrated vehicle jacks in accordance with a second preferred embodiment of the present invention. Panel A shows all jacks in an unactivated state while Panel B shows one jack in an activated state.

FIG. 4 illustrates a perspective view of a vehicle jacking system in accordance with a preferred embodiment of the present invention.

### DETAILED DESCRIPTION OF THE INVENTION

The following description of preferred embodiments of the invention provides examples of the present invention. The embodiments discussed herein are merely exemplary in nature, and are not intended to limit the scope of the invention in any manner. Rather, the description of these preferred embodiments serves to enable a person of ordinary skill in the relevant art to make and use the present invention.

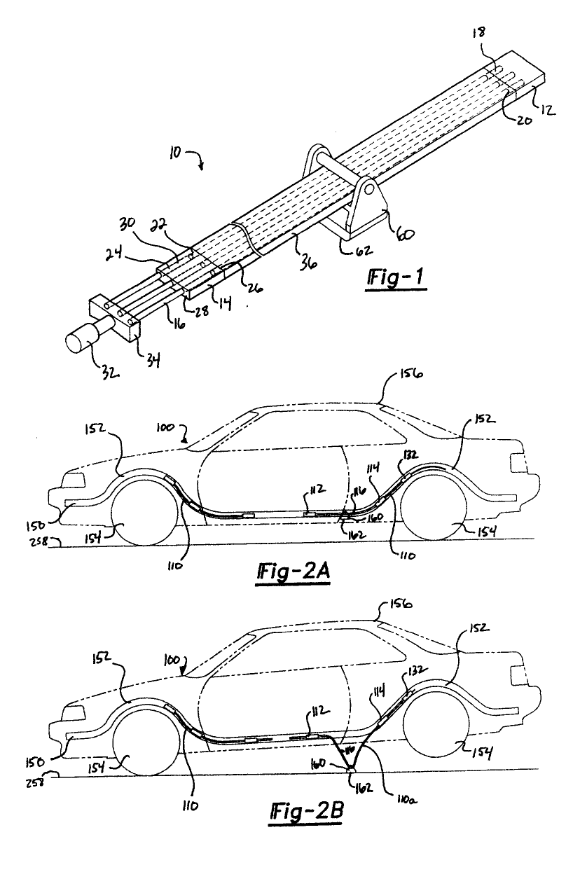

FIG. 1 illustrates an example of a vehicle jack 10 in accordance with a preferred embodiment of the present invention. The jack 10 includes a base member 12 and a guide member 14. One or more flexible rods 16 extend into both the base 12 and guide 14 members. The base 12 and guide 14 members are preferably secured to a surface, such as a vehicle chassis (not illustrated in FIG. 1).

The base member 12 preferably defines one or more openings 20 that receive and retain a first end 18 of the rods 16. In the base member 12, the openings 20 preferably retain the first end 18 such that the rod 16 cannot move within the opening 20. The first end 18 may be secured in the opening 20 by any of a variety of means, including an adhesive bond between the rod 16 and base member 12, mechanical attachment, such as crimping or by way of a fastener, and any other suitable attachment means. Alternatively, the rod 16 can be secured to a face of the base member 12.

The guide member 14 defines openings 22 that provide a passageway 24 from a first face 26 to an opposing second face 28 of the member 14. Each opening 22 receives a second end 30 of the rod 16 and allows the second end 30 to move freely within the passageway 24. Preferably, the second end 30 of the rod 16 extends past the second face 28 so that the rod 16 can be deformed by passing a portion of the second end 30 into the passageway 24, as will be developed more fully below.

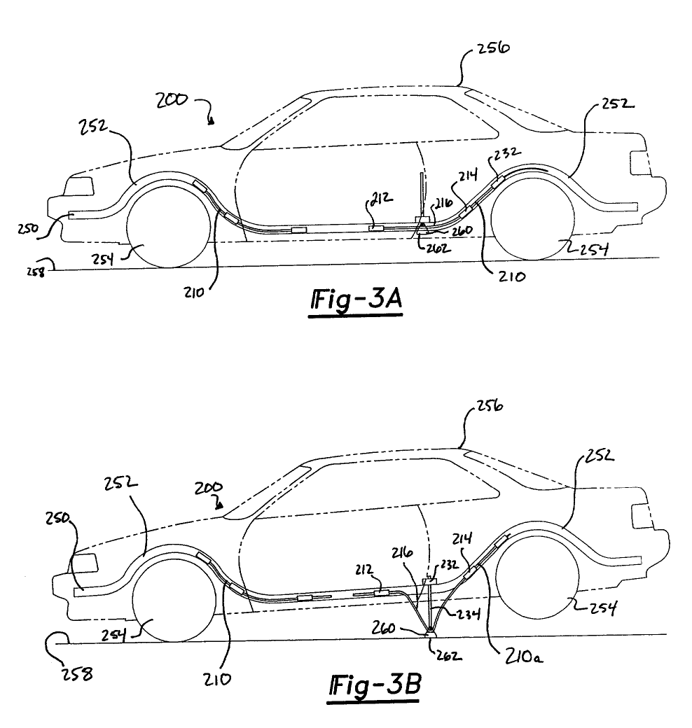

The rod 16 is preferably flexible in nature. Preferably, the rod 16 comprises a composite material that is sufficiently flexible to allow the rod 16 to extend from a vehicle chassis to the ground, as shown in FIGS. 2 and 3. Composite materials, such as carbon fiber and polymeric materials, provide the desired flexibility when acted upon by an external mechanical force, such as a pushing or pulling action, which will be developed more fully below. As an alternative to composite materials, the rods 16 can comprise any material that possesses the desired flexibility, including flexible metals. Suitable alternative materials include aluminum, steel, alloyed iron, and any other suitable material that possesses the desired flexibility and strength.

The rod 16 preferably comprises an elongate member having a circular, square, rectangular, or triangular cross-sectional shape. Preferably, the cross-sectional shape provides a flat surface for interacting with the ground, as illustrated in FIGS. 2 and 3, which facilitates supporting a vehicle with the jack 10. Of course, any suitable shape can be utilized. The shape need only be adapted to allow the rod 16 to be secured to the base member 12 and threaded through the passageway(s) 24 of the guide member 14. An example of a suitable alternative shape is the configuration of the flexible plate described in U.S. Pat. No. 5,810,291 to Geiger, et al. for a CONTINUOUS MOLDLINE TECHNOLOGY SYSTEM, which is herby incorporated by reference in its entirety. Of course, the shape of the passageway(s) 24 is preferably complimentary to that of the rod 16 such that the desired flexibility can be achieved.

The jack 10 also preferably includes an actuator 32. The actuator 32 is a device capable of inducing stretching of the rod 16. The type of actuator used will depend on the nature of the rod 16. For example, a mechanical actuator can be utilized to push or pull the rod 16 such that the desired stretching is achieved. The actuator 32 preferably comprises a motor or other device capable of inducing deformation of the rod 16, either directly or indirectly. Particularly preferred, as illustrated in FIG. 1, the actuator 32 is a motor having a cam 34 or arm that can induce deformation in the rod 16 through a pushing or pulling action. Alternatively, any other suitable actuator that can induce the desired deformation can be utilized, such as actuators employing hydraulic pneumatic, or electrical means of inducing movement.

The actuator 32 can interact with the jack 10 to achieve the desired stretching in a variety of ways. Preferably, as illustrated in FIG. 1, the cam 34 or arm of the actuator 32 can be attached to the second 30 end of the rod 16 such that the actuator 32 can push or pull the rod 16 into or out of the passageways 24. Alternatively, as will be developed more fully below, the cam 34 can be positioned such that it pushes or pulls the rod at another location along the length of the rod, such that the second end of the rod moves with respect to the guide member and subsequently deforms. Also, it is preferred that the actuator be able to induce stretching in all rods in the jack, if more than one are present. Alternatively, the actuator may induce stretching in only one rod, or a subset of rods.

As illustrated in FIG. 1, the jack 10 may also include a flexible panel 36 that surrounds the rod 16 and is disposed between the base 12 and the guide 14 members. The flexible panel 16 provides a smooth, continuous surface, which confers an aesthetically pleasing look to the jack 10 and can also provide more surface area for contacting the ground when the jack 10 is activated, thereby providing stability. If present, the flexible panel 16 preferably comprises a flexible polymeric material that surrounds the portion of the rod 16 that lies between the base 12 and guide 14 members. Particularly preferable, the flexible panel 36 comprises an elastomeric material. Alternatively, the flexible panel 36 can comprise any flexible material that is able to stretch or deform to a desired degree and return to its original form. The appropriate degree of ability to deform will depend on the application. For applications of the present invention, the flexible panel 36 is preferably capable of stretching to 150% of its normal length and still be able to return to its original length and form. Examples of suitable materials for use in the flexible panel of the present invention include rubber, silicones, silicone rubbers, polyurethanes, and flexible acrylics.

If present, the flexible panel 36 defines one or more cavities 38 that receive the rod 16. Preferably, the number, size and shape of the cavities 38 is complimentary to the number, size and shape of rods 16 present in the jack 10.

The support member 60 provides a support base for contacting the ground or other support surface. Preferably, the support member 60 comprises a member having a base 62 with a larger surface area than the section of the flexible rod 16 that would encounter the ground in the absence of the support member 60.

FIG. 2 illustrates a first preferred embodiment of a vehicle jacking system 100 in accordance with the present invention. Like reference numbers in FIG. 2 refer to similar features and/or components illustrated in FIG. 1. In FIG. 2, panel A illustrates a jacking system 100 in which all jacks 110 are in an unactivated, or non-deformed state, while panel B illustrates one jack 110a in an activated state.

As shown in the figure, the jacking system 100 includes one or more vehicle jacks 110 mounted to a vehicle chassis 150. The chassis provides a support frame onto which vehicle component can be mounted. The chassis 150 can be any suitable vehicle chassis, including those for use with automobiles, light trucks, sport utility vehicles, and commercial trucks.

Typical vehicle chassis define an appropriate number of recesses 152 for receiving a wheel 154 of the vehicle 156. As illustrated in FIG. 2, the jacks 110 of the present invention are preferably mounted near the recesses 152 such that deformation of the rod 116 elevates a wheel 154 mounted within the recess 152.

The jacks 110 are individually mounted to the structural supports of the chassis 150. Preferably, the base 112 and guide 114 members of the jack 1 10 are fixedly attached to the chassis 150. Any suitable securement means, such as welding and suitable fasteners, can be used to achieve this attachment.

Also preferable, the base 112 and guide 114 members are positioned such that the rod 116 follows the contours of the chassis 150 when the jack is not activated. This allows the jack 110 to be substantially concealed when in its non-activated state.

The jacks 110 in the system 100 according to the first preferred embodiment have actuators 132 positioned as shown in FIG. 1. That is, the arm 134 of each actuator is attached to the second end 130 of the appropriate rod 116. These jacks 110 operate by activating each actuator 132, either individually or in combination, to push or pull on the respective rod 116 such that the second end 130 moves through the passageway 124, forcing the rod 116 to deform. Once the deformed rod 116 encounters the ground 158, continued deformation forces the vehicle 156 to become elevated.

As illustrated in FIG. 2, vehicle jacks 110 according to the present invention can further include a support member 160 attached to the flexible rod 116. The support member 160 provides a support base for contacting the ground or other support surface. Preferably, the support member 160 comprises a member having a base 162 with a larger surface area than the section of the flexible rod 116 that would encounter the ground in the absence of the support member 160. Thus, it is preferred that a width of the support member 160 is greater than the width of the flexible rod 116 at the point at which these two elements are connected. This provides more stability to the vehicle jack 110. Also preferable, the support member 160 is pivotally attached to the flexible rod 116. The pivotal relationship between the support member 160 and the rod 116 allows the support member 160 to move into a position in which the base is adjacent the ground as the jack 110 is deployed. Alternatively, the support member 160 can be fixedly secured to the rod 116 in an orientation that ensures stable contact between the base 162 and ground when the jack 110 is deployed.

FIG. 3 illustrates a jacking system 200 in accordance with a second embodiment of the present invention. This embodiment is similar to the first preferred embodiment except as detailed below. Like reference numbers in FIG. 3 refer to similar features and/or components of the first preferred embodiment. As in FIG. 2, panel A of FIG. 3 illustrates a jacking system 200 in which all jacks 210 are in an unactivated, or non-deformed state, while panel B illustrates one jack 210a in an activated state.

In this embodiment, the actuator 232 is adapted to interact with the rod 216 at a point between the base 212 and guide 214 members. As illustrated in FIG. 3, an arm 234 of the actuator 232 is directed at the rod 216 at a point between the base 212 and guide 214 members. The arm 234 can be attached to the rod 216, or a clearance can exist between the arm 234 and these elements. If attached, the arm 234 is preferably adapted to push and pull the rod 216, thereby inducing deformation of the rod 216. If a clearance exists between the arm 234 and these elements, the actuator 232 induces deformation of the rod 216 by extending the arm 234 to a point at which it encounters the rod 216 and subsequently pushing on the rod 216. This arrangement does not allow the actuator 232 to induce deformation by pulling on the rod 216.

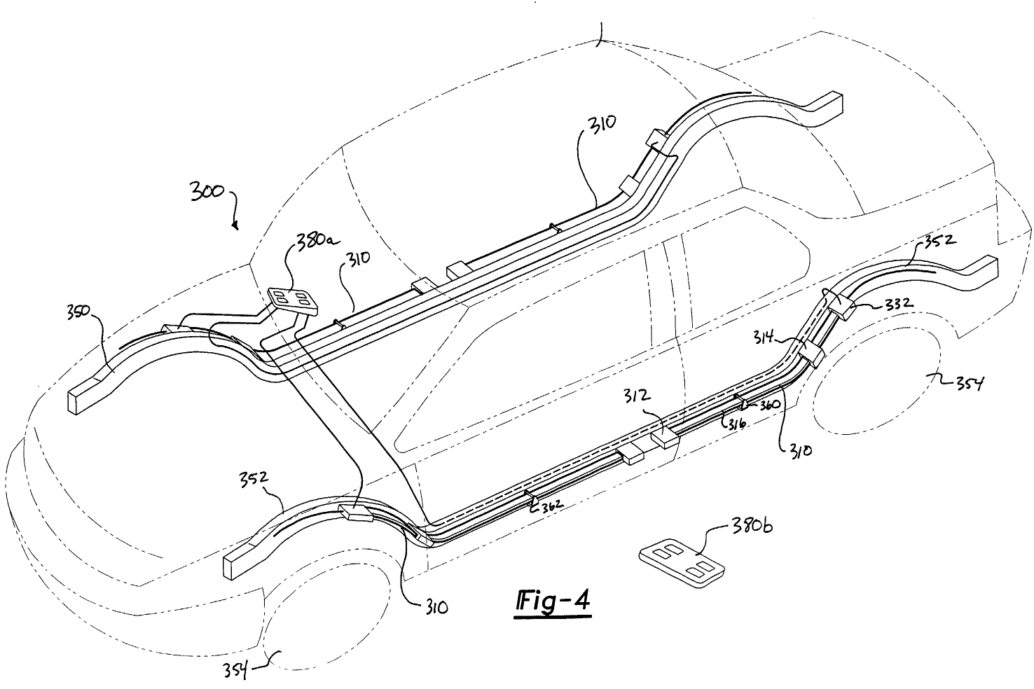

As illustrated in FIG. 4, the second end 230 of the rod 216 in this embodiment is preferably not attached to the actuator 232.

FIG. 4 illustrates a vehicle jacking system 300 that incorporates a controller 380. This embodiment is similar to the first preferred embodiment except as detailed below, and like reference numbers in FIG. 4 refer to similar features and/or components illustrated in FIGS. 1 and 2.

In this embodiment, a controller 380 is operably connected to the actuator(s) 332 of the jacks 310 in the system 300. Preferably, the controller 380 comprises a switch or other manual controller (illustrated at 380a in the figure) capable of initiating action by one or more actuators 332 of the jacks 310. Also preferable, the controller 380a is in electrical or mechanical communication with the actuator 332. Further, it is preferred that the controller 380a be disposed within a passenger compartment of the vehicle 356. As illustrated in FIG. 4, the controller 380 is preferably operably connected to the actuator 332 of each jack 310 in the system. Alternatively, the controller 310 can be connected to only a single actuator 332 of a single jack 310, or to a subset of the jacks 310 present in the system 300.

Alternatively, the controller 380 can comprise a remote control unit (illustrated at 380b in the figure) that is adapted to remotely activate one or more of the actuators 332 to induce deformation of the rod(s) 316. Conventional remote control technology is preferably employed to establish the desired operable connection between the remote control unit 380b and the actuators 332 of the jacks 310.

It should be noted that, while the jacking system incorporates jacks according to the first preferred embodiment, the system can also incorporate jacks according to the second preferred embodiment.

The foregoing disclosure is the best mode devised by the inventors for practicing the invention. It is apparent, however, that several variations in accordance with the present invention may be conceivable to one of ordinary skill in the relevant art. Inasmuch as the foregoing disclosure is intended to enable such person to practice the instant invention, it should not be construed to be limited thereby, but should be construed to include such aforementioned variations. As such, the present invention should be limited only by the spirit and scope of the following claims.

We claim:

1. A vehicle jack for elevating a vehicle above a support surface, comprising:
a base member adapted to be secured to said vehicle;
a guide member having first and second opposing faces and defining a passageway extending between the first and second opposing faces;
at least one flexible rod having first and second ends, the first end being fixedly attached to the base member and the second end being disposed in the passageway and being capable of slideable movement within the passageway;
a support member attached to the flexible rod and adapted to contact said support surface; and
an actuator adapted to induce deformation of the rod by causing the second end of the rod to move with respect to the passageway.

2. A vehicle jack in accordance with claim 1, further comprising a flexible panel disposed around the rod and between the base and guide members.

3. A vehicle jack in accordance with claim 1, further comprising a controller operably connected to the actuator, wherein the controller is adapted to selectively induce the actuator to induce deformation of the rod.

4. A vehicle jack in accordance with claim 3, wherein the controller is positioned within a passenger compartment of said vehicle.

5. A vehicle jack in accordance with claim 3, wherein the controller comprises a remote control unit.

6. A vehicle jack in accordance with claim 1, wherein the support member is pivotally attached to the flexible rod.

7. A vehicle jack in accordance with claim 1, wherein the support member includes a base surface having a width that is larger than the width of the flexible rod.

8. A vehicle jack in accordance with claim 1, wherein the flexible rod comprises a plurality of flexible rods twisted together.

9. A vehicle jack in accordance with claim 1, wherein the flexible rod is comprised of a material selected from a group consisting of a carbon-fiber composite material, aluminum, steel, and alloyed iron.

10. A vehicle jack in accordance with claim 1, wherein the rod has a cross-sectional shape of a member selected from the group consisting of a square, a rectangle, and a triangle

11. A vehicle chassis, comprising:
a support frame defining one or more recesses for receiving a wheel; and
a vehicle jack mounted to the support frame, the jack adapted to elevate the chassis above a support surface and comprising a base member, a guide member having first and second opposing faces and defining a passageway extending between the first and second opposing faces, at least one flexible rod having first and second ends, the first end being fixedly attached to the base member and the second end being disposed in the passageway and being capable of slideable movement within the passageway, and an actuator adapted to induce deformation of the rod by causing the second end of the rod to move with respect to the passageway.

12. A vehicle chassis in accordance with claim 11, wherein the vehicle jack is mounted to the support frame at a point near one of the recesses.

13. A vehicle chassis in accordance with claim 11, further comprising a second vehicle jack mounted to the support frame.

14. A vehicle chassis in accordance with claim 11, wherein the base and guide members are both fixedly secured to the support frame.

15. A vehicle chassis in accordance with claim 11, wherein the vehicle jack further comprises a support member attached to the flexible rod.

16. A vehicle chassis in accordance with claim 15, wherein the support member is pivotally attached to the flexible rod.

17. A vehicle chassis in accordance with claim 15, wherein the support member includes a base surface having a width that is larger than the width of the flexible rod.

18. A vehicle jacking system for elevating a vehicle above a support surface, comprising:
a vehicle chassis;
a vehicle jack mounted to the chassis comprising a base member, a guide member having first and second opposing faces and defining a passageway extending between the first and second opposing faces, at least one flexible rod having first and second ends, the first end being fixedly attached to the base member and the second end being disposed in the passageway and being capable of slideable movement within the passageway, and an actuator adapted to induce deformation of the rod by causing the second end of the rod to move with respect to the passageway; and
a controller operably connected to the actuator of the vehicle jack, the controller being adapted to selectively induce the actuator to induce deformation of the rod.

19. A vehicle jacking system in accordance with claim 18, wherein the controller is positioned within a passenger compartment of said vehicle.

20. A vehicle jacking system in accordance with claim 18, wherein the controller comprises a remote control unit.
